(19) United States
(12) Patent Application Publication
(10) Pub. No.: US 2024/0332578 A1
(43) Pub. Date: Oct. 3, 2024

(54) COMPOSITE GAS DIFFUSION LAYER AND PREPARATION METHOD THEREOF, MEMBRANE ELECTRODE AND ELECTROCHEMICAL HYDROGEN COMPRESSOR

(71) Applicant: SOUTHERN UNIVERSITY OF SCIENCE AND TECHNOLOGY, Shenzhen (CN)

(72) Inventors: Jiexin ZOU, Shenzhen (CN); Min WANG, Shenzhen (CN); Haijiang WANG, Shenzhen (CN)

(21) Appl. No.: 18/208,058

(22) Filed: Jun. 9, 2023

(30) Foreign Application Priority Data
Mar. 27, 2023 (CN) 202310358367.X

(51) Int. Cl. H01M 8/0656; H01M 4/86; H01M 4/88; H01M 8/04291; H01M 8/1004

(52) U.S. Cl. CPC H01M 8/0656; H01M 4/8605; H01M 4/8668; H01M 4/8807; H01M 4/8828; H01M 8/04291; H01M 8/1004

(57) ABSTRACT

The present application relates to the technical field of compressors, and in particular, to a composite gas diffusion layer, a preparation method thereof, a membrane electrode, and an electrochemical hydrogen compressor. The composite gas diffusion layer applied to an electrochemical hydrogen compressor includes: a base layer, a hydrophobic layer, and a water-absorbing layer, and the base layer, the hydrophobic layer, and the water-absorbing layer are sequentially stacked. The composite gas diffusion layer of the present application is designed for an inherent problem of the drying up of the anode during the operation of the electrochemical hydrogen compressor, and by arranging a layered structure for water absorption/hydrophobicity, the composite gas diffusion layer can improve the compression performance of the membrane electrode of the compressor and reduce the ohmic impedance of the membrane electrode.

### CROSS-REFERENCE TO RELATED APPLICATIONS

This application claims the benefit of Chinese patent application No. 202310358367.X filed on Mar. 27, 2023, titled “COMPOSITE GAS DIFFUSION LAYER AND PREPARATION METHOD THEREOF, MEMBRANE ELECTRODE AND ELECTROCHEMICAL HYDROGEN COMPRESSOR”, the entire contents of which are incorporated herein by reference.

### TECHNICAL FIELD

The present application relates to the technical field of compressors, and in particular, to a composite gas diffusion layer, a preparation method thereof, a membrane electrode, and an electrochemical hydrogen compressor.

### BACKGROUND

During the compression process of an electrochemical hydrogen compressor (EHC), the anode undergoes a hydrogen oxidation reaction to generate protons, and the electroosmotic migration effect in the proton exchange membrane allows a large amount of water to migrate from the anode to the cathode. Many studies have found that the unbalanced contribution of electroosmotic migration and back-diffusion of water can significantly affect the overall efficiency of the EHC. Therefore, effective water management in the gas diffusion layer is the key to improving the performance of electrochemical hydrogen compressors. At present, few studies have been carried out on the gas diffusion layer structure of the electrochemical hydrogen compressor system. Most of the research and applications directly use the combination of “hydrophobic base layer+super hydrophobic microporous layer” in the fuel cell as the gas diffusion layer of the electrochemical hydrogen compressor, but the application of this gas diffusion layer structure is not designed for the operating mechanism and actual working conditions of the electrochemical hydrogen compressor, so that the compression performance of the electrochemical hydrogen compressor has not been optimized.

The working principle of the electrochemical hydrogen compressor is as follows: when a low-pressure hydrogen gas flow enters an anode chamber, the hydrogen passes through the gas diffusion layer to the catalytic layer. Under a voltage by an external circuit, the gas is driven to oxidize hydrogen molecules into protons and electrons, and then the protons are transferred to the cathode through a proton exchange membrane. The protons in the proton exchange membrane will hydrate with one or more water molecules to form hydrated protons. The protons migrate from the anode to the cathode under the electric field, and at the same time drag the water molecules from the anode to the cathode. The positively charged hydrogen protons interact with the negatively charged electron density in contact with the water molecules to form dynamic matter composed of aggregates of water molecules and interacting protons. The electrons are conducted to an external circuit. In the cathode chamber, the protons transmitted from the anode through the electrolyte membrane combine with the electrons transmitted from the external circuit to recombine into hydrogen molecules, converting electrical energy into compression energy to obtain high-pressure hydrogen. Therefore, the anode of the electrochemical hydrogen compressor will dry up during the long-term operation.

In the existing technology, the gas diffusion layers used for electrochemical hydrogen compressors are mainly divided into two classes, the carbon-based and the metal-based, according to the materials selection. The carbon-based materials used directly adopt the commercial structure of “hydrophobic base layer+super-hydrophobic microporous layer” in fuel cells. The metal-based materials are mostly foam metal, sintered metal mesh, metal sintered powder, etc. However, the metal-based materials directly assembled with a membrane electrode are easy to damage the membrane electrode due to their rough surface, so a carbon-based diffusion layer is often used as a buffer layer between the membrane electrode and the metal-based diffusion layer. Therefore, the carbon-based gas diffusion layers have broad applicability in electrochemical hydrogen compressors. However, when the gas diffusion layer is applied to the electrochemical hydrogen compressor in the existing technology, the problem of anode drying up in the compressor cannot be solved, which leads to poor compression performance of the compressor membrane electrode in a low-humidity environment and high ohmic impedance.

### SUMMARY

In order to overcome deficiencies in the existing technology, a first aspect of the present application provides a composite gas diffusion layer, in order to promote the water absorption and water retention effect of the gas diffusion layer, thereby overcoming the drying up of the anode of the electrochemical hydrogen compressor, improving the compression performance of the membrane electrode of the compressor, and reducing the ohmic impedance of the membrane electrode.

A second aspect of the present application provides a preparation method of a composite gas diffusion layer, in order to prepare a gas diffusion layer suitable for an electrochemical hydrogen compressor, thereby improving the compression performance of the compressor membrane electrode and reducing the ohmic impedance of the membrane electrode.

A third aspect of the present application provides a membrane electrode.

A fourth aspect of the present application provides an electrochemical hydrogen compressor.

In the first aspect, a technical proposal of the present application is as follows:
a composite gas diffusion layer, which is applied to an electrochemical hydrogen compressor, including: a base layer, a hydrophobic layer, and a water-absorbing layer, and the base layer, the hydrophobic layer, and the water-absorbing layer are sequentially stacked.

Further, the water-absorbing layer includes following components by weight percentage:

| | |
|---|---|
| a first carbon black | 5%-10%; |
| a water-absorbing agent | 5%-20%; and |
| a first solvent | 70%-90%; |

the hydrophobic layer includes following components in weight percentage:

| | |
|---|---|
| a second carbon black | 4%-10%; |
| a hydrophobic agent | 4%-10%; |
| a binder | 0.5%-3%; and |
| a second solvent | 77%-90%. |

Further, the water-absorbing agent includes one or a combination of two or more of nitric acid, hydrophilic silicon dioxide, hydrophilic titanium dioxide, hydrophilic tin dioxide, polyvinyl alcohol, cellulose, perfluorosulfonic acid resin solution, and agarose; and/or
the first solvent includes one or a combination of two or more of ethanol, water, ethylene glycol, and n-propanol or isopropanol; and/or
the second solvent includes one or a combination of two or more of ethanol, water, ethylene glycol, and n-propanol or isopropanol.

Further, the hydrophobic agent includes one or a combination of two or more of polytetrafluoroethylene, polyvinylidene fluoride, polychlorotrifluoroethylene, and a tetrafluoroethylene-hexafluoropropylene copolymer or a tetrafluoroethylene-perfluoro(alkyl vinyl ether) copolymer; and/or

The binder includes sodium carboxymethylcellulose.

Further, the base layer includes one or a combination of two or more of carbon fiber cloth, carbon fiber felt, carbon fiber paper, stainless steel mesh, foamed titanium, titanium felt, and powder sintered titanium plate.

Further, an aperture of more than 80% of pores in the base layer is 50 μm-200 μm, an aperture of the hydrophobic layer is 5 μm-50 μm, and an aperture of the water-absorbing layer is 1 μm-50 μm; and
a thickness of the water-absorbing layer is 10 μm-65 μm, a thickness of the hydrophobic layer is 10 μm-65 μm, and a thickness of the base layer is 100 μm-300 μm.

In the second aspect, a technical proposal of the present application is as follows:
a preparation method for a composite gas diffusion layer, including the following steps:

Step S1: preparing a hydrophobic layer, including preparing a hydrophobic slurry from raw material components used in the hydrophobic layer, applying the hydrophobic slurry on a surface of a base layer, carrying out a drying treatment, and sintering to form the hydrophobic layer:

Step S2: preparing a water-absorbing layer: preparing a water-absorbing slurry from raw material components used in the water-absorbing layer, applying the water-absorbing slurry on a surface of the hydrophobic layer, and carrying out a second drying treatment to obtain a composite gas diffusion layer.

In the above-mentioned technical proposals, in step S1, the raw material components used in the hydrophobic layer are stirred at a speed of 500 rpm/min-1500 rpm/min for 2.5 hrs-3.5 hrs and are left to stand for 5 hrs-15 hrs to obtain the hydrophobic slurry, and then the hydrophobic slurry is applied on the base layer by scraping, spray coating or roll coating, and is firstly dried at 70° C.-90° C. for 15 mins-25 mins, then baked at 240° C.-260° C. for 25 mins-35 mins, and then heated up to 340° C.-360° C. for sintering for 25 mins-35 mins to form the hydrophobic layer on the surface of the base layer.

After the hydrophobic slurry is coated on the base layer, the coated base layer is sintered at 340° C.-360° C. for 25 mins-35 mins, so that the hydrophobic agent can melt and bond carbon black particles, and finally form a hydrophobic layer with good integrality on the surface of the base layer.

In the above-mentioned technical proposal, in step S2, the raw material components used in the water-absorbing layer are stirred at a speed of 500 rpm/min-1500 rpm/min for 2.5 hrs-3.5 hrs, and are left to stand for 1.5 hrs-2.5 hrs to obtain the water-absorbing slurry, and then the water-absorbing slurry is applied on the hydrophobic layer by scraping, spray coating or roll coating, and is dried at a temperature from the room temperature to 90° C. for 15 mins-30 mins to obtain the composite gas diffusion layer.

In the third aspect, a technical proposal of the present application is as follows:
a membrane electrode, including a catalytic layer and the above-mentioned composite gas diffusion layer, and the water-absorbing layer in the composite gas diffusion layer is fitted on the catalytic layer.

In the fourth aspect, a technical proposal of the present application is as follows:
an electrochemical hydrogen compressor, including the above-mentioned membrane electrode.

The advantageous effects of the present application compared to existing technologies are as that:

(1) The composite gas diffusion layer of the present application is designed for an inherent problem of the drying up of the anode during the operation of the electrochemical hydrogen compressor, and, combined with the working principle of the electrochemical hydrogen compressor, by arranging a layered structure for water absorption/hydrophobicity from the membrane electrode side, the composite gas diffusion layer can improve the compression performance of the compressor membrane electrode and reduce the ohmic impedance of the membrane electrode.

(2) In the composite gas diffusion layer of the present application, by arranging the composite gas diffusion layer having the water absorption/hydrophobic layers from the membrane electrode side, combining the ratio of water-absorbing and hydrophobic substances in each layer, the difference in water absorption capability between the layers is realized, so that a difference in the water concentration from high to low is obtained from the water-absorbing layer to the base layer of the anode, which can greatly improve the water conduction efficiency in the membrane electrode, thereby improving the polarization and compression performance of the electrochemical hydrogen compressor under low humidity.

(3) During the operation of the electrochemical hydrogen compressor, the moisture on the anode side of the membrane electrode passes through the gas diffusion layer to the catalytic layer, and then continues to be transported to the cathode side through the electroosmotic migration in the proton exchange membrane, so that an inherent problem of anode drying up will occur, and under low humidity on the anode side, the entered reaction gas will carry water in the membrane electrode, which will affect the electrochemical performance of the electrochemical hydrogen compressor and reduce the operating life. During the operation of the electrochemical hydrogen compressor, since the composite gas diffusion layer of the present application has the composite microporous layer with a layered structure of water absorption/hydrophobicity, the water-absorbing layer in contact with the anode side of the membrane electrode plays a role in water absorption and storage, the hydrophobic layer adjacent to the water-absorbing layer can effectively prevent the loss of water in the water-absorbing layer for water retention, the water-absorbing layer and the hydrophobic layer in the composite gas diffusion layer of the present application have a synergistic effect in maintaining moisture on the anode, thereby avoiding the inherent problem of anode drying up, thus greatly improving the compression rate of the electrochemical hydrogen compressor in a low-humidity environment, and reducing the ohmic impedance of the membrane electrode.

(4) In the preparation method of a composite gas diffusion layer of the present application, a composite gas diffusion layer is prepared by preparing a water-absorbing layer and a hydrophobic layer; during the preparation of the hydrophobic layer, a hydrophobic slurry is coated on a base layer, dried, and heated up for sintering, so that the hydrophobic agent can melt and bond carbon black particles to form the hydrophobic layer with good integrality on the surface of the base layer, thereby improving the water retention effect of the hydrophobic layer. Moreover, during the preparation of the water-absorbing layer, a water-absorbing slurry is coated on the hydrophobic layer followed by only a drying process to obtain the water-absorbing layer. The drying process is not performed at a high temperature so that the prepared water-absorbing layer forms a uniform porous structure, thereby making the water-absorbing layer have a good water-absorbing effect.

(5) The preparation method of a composite gas diffusion layer of the present application is simple and suitable for large-scale production.

(6) The electrode membrane of the present application includes a catalytic layer and a composite gas diffusion layer, thus the inherent problem of the drying up of the anode during the operation of the electrochemical hydrogen compressor can be avoided, thereby improving the compression performance of the electrode membrane of the electrochemical hydrogen compressor, and reducing the ohmic impedance of the membrane electrode.

(7) The electrochemical hydrogen compressor of the present application overcomes the inherent problem of the drying up of the anode during the operation of the electrochemical hydrogen compressor, thereby improving the compression performance, particularly enhancing the compression rate of the electrochemical hydrogen compressor in a low-humidity environment.

### BRIEF DESCRIPTION OF THE DRAWINGS

In order to more clearly illustrate the technical proposals in embodiments of the present application, accompanying drawings that are used in the description of the embodiments or exemplary existing technologies are briefly introduced hereinbelow. Obviously, the drawings in the following description are merely some embodiments of the present application. For those skilled in the art, other drawings can also be obtained according to these drawings without any creative effort.

FIG. 1 is a schematic diagram showing the structure of a composite gas diffusion layer according to the present application;

FIG. 2 is a schematic diagram showing the structure of a membrane electrode according to the present application:

FIG. 3 is a scanning electron microscope (SEM) image of the composite gas diffusion layer prepared according to Example 1 of the present application:

FIG. 4 is an SEM image of the composite gas diffusion layer prepared according to Example 2 of the present application:

FIG. 5 is an SEM image of the composite gas diffusion layer prepared according to Example 3 of the present application:

FIG. 6 is an SEM image of a hydrophobic gas diffusion layer prepared according to Comparative Example 1 of the present application:

FIG. 7 is a chart showing the hydrophobic contact angles of the gas diffusion layers prepared according to Comparative Example 1 and Examples 1-3 from the experimental tests of the present application:

FIG. 8 is a chart showing the ohmic impedance of corresponding membrane electrodes of the gas diffusion layers prepared according to Comparative Example 1 and Examples 1-3 from the experimental tests of the present application:

FIG. 9 is a diagram showing the comparison between the ohmic impedance of the membrane electrodes of the gas diffusion layers prepared according to Comparative Example 1 and Example 3 from the experimental tests of the present application:

FIG. 10 shows the compressive performance curves under 100% relative ambient humidity of the corresponding membrane electrodes of the gas diffusion layers prepared according to Comparative Example 1 and Examples 1-3 obtained from the experimental tests of the present application:

FIG. 11 shows the compressive performance curves under 50% relative ambient humidity of the corresponding membrane electrodes of the gas diffusion layers prepared according to Comparative Example 1 and Examples 1-3 obtained from the experimental tests of the present application:

FIG. 12 shows the compressive performance curves under 100% ambient relative humidity of the corresponding membrane electrodes of the composite gas diffusion layer with a single-layer water-absorbing layer prepared according to Example 2 and the composite gas diffusion layer with a double-layer water-absorbing layer prepared according to Example 4 obtained from the experimental tests of the present application:

FIG. 13 shows the compressive performance curves under 50% ambient relative humidity of the corresponding membrane electrodes of the composite gas diffusion layer with a single-layer water-absorbing layer prepared according to Example 2 and the composite gas diffusion layer with a double-layer water-absorbing layer prepared according to Example 4 obtained from the experimental tests of the present application; and

FIG. 14 is a chart showing the ohmic impedance of corresponding membrane electrodes of the composite gas diffusion layer with a single-layer water-absorbing layer prepared according to Example 2 and the composite gas diffusion layer with a double-layer water-absorbing layer prepared according to Example 4.

Reference numbers in the drawings are as follows:
1—base layer, 2—hydrophobic layer, 3—water-absorbing layer, and 4—catalytic layer.

### DETAILED DESCRIPTION OF THE EMBODIMENTS

In order to make the technical problem to be solved, technical proposals and beneficial effects in the present application clearer, the present application will be described in further detail in conjunction with the embodiments. It should be understood that the specific embodiments described here are only used to explain the present application, not to limit the present application.

It should be understood that in various embodiments of the present application, the sequence numbers of the above-mentioned processes do not represent the order of execution, and some or all of the steps can be performed in parallel or successively, and the order of execution of each process should be determined by the function and internal logic, and should not constitute any limitation to the implementation process of the embodiment of the present application.

The terms used in the embodiments of the present application are only for the purpose of describing specific embodiments, and are not intended to limit the present application. As used herein, the singular forms “a”, “said” and “the” as used in the examples and appended claims are intended to include the plural forms as well, unless the context clearly dictates otherwise.

During the operation of an electrochemical hydrogen compressor, the moisture on the anode side of the membrane electrode first passes through the gas diffusion layer to the catalyst layer, and is continuously transported to the cathode side by the electroosmotic migration in the proton exchange membrane, thus an inherent problem of drying up of the anode will occur under low humidity on the anode side, the reaction gas entering the membrane electrode will also carry moisture in the membrane electrode away, which will affect the electrochemical performance of the electrochemical hydrogen compressor and reduce the operating life. Therefore, an embodiment of the present application provides a composite gas diffusion layer to improve the water absorption and water retention effect of the gas diffusion layer, and further aims to solve the problem of drying up of the anode of the electrochemical hydrogen compressor, thereby improving the compression performance of the membrane electrode of the compressor and reducing the ohmic impedance of the membrane electrode.

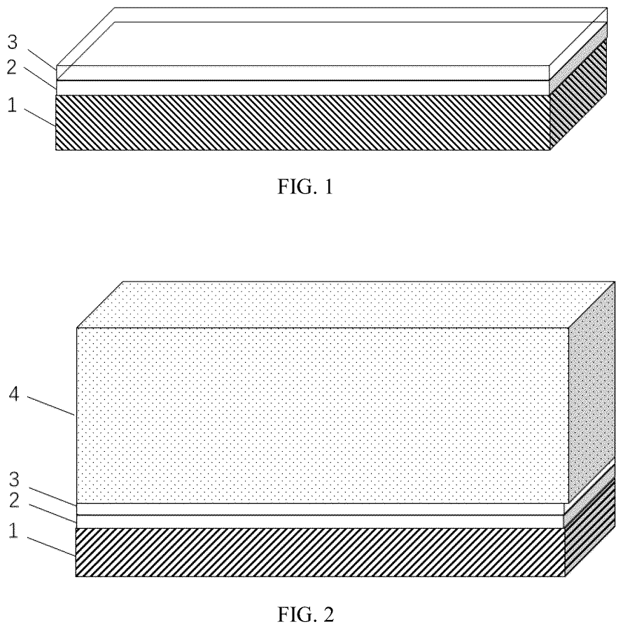

In the embodiment of the present application, as shown in FIG. 1, a composite gas diffusion layer, which is applied to an electrochemical hydrogen compressor, includes a base layer 1, a hydrophobic layer 2, and a water-absorbing layer 3, and the base layer 1, the hydrophobic layer 2, and the water-absorbing layer 3 are stacked in sequence.

With the composite gas diffusion layer applied to an electrochemical hydrogen compressor, when a low-pressure hydrogen gas flow enters an anode chamber, the hydrogen gas passes through the gas diffusion layer to the catalytic layer, here, the hydrogen gas sequentially passes through a base layer, a hydrophobic layer, and a water-absorbing layer to reach the catalytic layer. Since the water-absorbing layer has a good effect of absorbing water molecules, in combination with the water-retaining effect of the hydrophobic layer, the moisture on the anode can be maintained, which solves the inherent problem of drying up of the anode, thereby improving the compression rate of the electrochemical hydrogen compressor under low humidity, and reducing the ohmic impedance of the membrane electrode.

In some embodiments, the water absorbing layer includes following components in weight percent:

| | |
|---|---|
| a first carbon black | 5%-10%; |
| a water-absorbing agent | 5%-20%; and |
| a first solvent | 70%-90%. |

Here, the first carbon black as a relatively low-cost conductor is mainly used for electrical conduction in the electrochemical hydrogen compressor. The water-absorbing agent is evenly dispersed in the formed water-absorbing layer, and mainly plays the role of absorbing the moisture of the air flow.

In some embodiments, the hydrophobic layer includes following components in weight percentage:

| | |
|---|---|
| a second carbon black | 4%-10%; |
| a hydrophobic agent | 4%-10%; |
| a binder | 0.5%-3%; and |
| a second solvent | 77%-90%. |

Here, the second carbon black as a relatively low-cost conductor is mainly used for electrical conduction in the electrochemical hydrogen compressor. The hydrophobic agent plays a role of water-repelling in the formed hydrophobic layer, which can avoid the water loss from the adjacent water-absorbing through the hydrophobic layer, thereby achieving water retention. Furthermore, the binder can effectively facilitate the formation of a densely packed hydrophobic layer, whilst also enhancing the water retention capabilities of the layer.

In some embodiments, the water-absorbing agent includes one or a combination of two or more of nitric acid, hydrophilic silicon dioxide, hydrophilic titanium dioxide, hydrophilic tin dioxide, polyvinyl alcohol, cellulose, perfluorosulfonic acid resin solution, and agarose: the water-absorbing agents selected in the embodiment of the present application have relatively good water-absorbing capability so as to effectively absorb water in the water-absorbing layer, preventing the loss of water in the airflow:
and/or,
the first solvent includes one or a combination of two or more of ethanol, water, ethylene glycol, n-propanol or isopropanol: the first solvents selected in the embodiments of the present application can effectively disperse the water-absorbing agent and the first carbon black contained therein, with the advantages of low cost and being readily accessible:
and/or,
the second solvent includes one or a combination of two or more of ethanol, water, ethylene glycol, n-propanol or isopropanol: the second solvent selected in the embodiments of the present application allows the hydrophobic agent and the second carbon black to be effectively dispersed and better combined with the binder, with the advantages of low cost and being readily accessible.

In some embodiments, the hydrophobic agent includes one or a combination of two or more of polytetrafluoroethylene, polyvinylidene fluoride, polychlorotrifluoroethylene, a tetrafluoroethylene-hexafluoropropylene copolymer or a tetrafluoroethylene-perfluoro(alkyl vinyl ether) copolymer: the hydrophobic agents selected in the embodiments of the present application all have a good water-repellent effect, and the water-repellent effect of the hydrophobic can be enhanced by cooperation with the binder, so that a good water-retaining effect of the water-absorbing layer can be achieved, and the loss of water from the airflow can be prevented by the synergistic effect with the absorbent layer:
and/or,
the binder includes sodium carboxymethyl cellulose: as a binder, sodium carboxymethyl cellulose has good film-forming adhesive properties on the one hand, so that the entire hydrophobic layer forms a dense layer to prevent water loss from the water-absorbing layer: on the other hand, sodium carboxymethyl cellulose itself also has a good water retention effect, namely a hydration effect, which makes the water difficult to volatilize, resulting in an excellent water retention effect of the hydrophobic layer.

In some embodiments, the base layer includes one or a combination of two or more of carbon fiber cloth, carbon fiber felt, carbon fiber paper, stainless steel mesh, titanium foam, titanium felt, and powder sintered titanium plate. The base layers selected in the embodiments are all macroporous base layers, which facilitate the circulation of airflow and have a good supporting effect for the formation of a hydrophobic layer on the surface.

In some embodiments, the aperture of more than 80% of the pores in the base layer is 50 μm-200 μm, the aperture of the hydrophobic layer is 5 μm-50 μm, and the aperture of the water-absorbing layer is 1 μm-50 μm: in embodiments of the present application, the aperture of the base layer is macropores relative to the apertures of the hydrophobic layer and the water-absorbing layer, and the apertures of the hydrophobic layer and the water-absorbing layer are micropores relative to the aperture of the base layer. The macropores in the base layer facilitate airflow; and the micropores in the hydrophobic layer and the water-absorbing layer facilitate water absorption and water retention.

The thickness of the water-absorbing layer is 10 μm-65 μm, the thickness of the hydrophobic layer is 10 μm-65 μm, and the thickness of the base layer is 100 μm-300 μm.

In an embodiment of the present application, the thickness of the base layer is greater than the thickness of the hydrophobic layer and the water-absorbing layer, so that the base layer is served as the support to the hydrophobic layer and the water-absorbing layer. The thickness of the water-absorbing layer and the hydrophobic layer is designed according to the amount of water absorption and water retention.

An embodiment of the present application also provides a preparation method of a composite gas diffusion layer, which includes the following steps S1-S2:

In step S1, a hydrophobic layer is prepared: raw material components used in the hydrophobic layer are formulated into a hydrophobic slurry, and then the hydrophobic slurry is coated on a surface of a base layer followed by a drying treatment, and is sintered to form a hydrophobic layer on the surface of the base layer; and

In step S2, a water-absorbing layer is prepared: raw material components used in the water-absorbing layer are formulated into a water-absorbing slurry, and then the water-absorbing slurry is coated on the surface of the hydrophobic layer, followed by a second drying treatment to obtain a composite gas diffusion layer.

The preparation method of the present application is simple, during the preparation, the drying treatment is performed first, followed by heating up and sintering, so that the hydrophobic agent can melt and bond carbon black particles to form the hydrophobic layer with good integrality, thereby improving the water retention effect of the hydrophobic layer.

In some embodiments, in the step S1, the raw material components used in the hydrophobic layer are stirred at a speed of 500 rpm/min-1500 rpm/min for 2.5 hrs-3.5 hrs, and are left to stand for 5 hrs-15 hrs to obtain the hydrophobic slurry, and then the hydrophobic slurry is applied on the base layer by scraping, spraying or rolling, and is firstly dried at 70° C.-90° C. for 15 mins-25 mins, then baked at 240° C.-260° C. for 25 mins-35 mins, and then heated up to 340° C.-360° C. for sintering for 25 mins-35 mins to form the hydrophobic layer on the surface of the base layer.

In some embodiments, in the step S2, the raw material components used in the water-absorbing layer are stirred at a speed of 500 rpm/min-1500 rpm/min for 2.5 hrs-3.5 hrs, and are left to stand for 1.5 hrs-2.5 hrs to obtain the water-absorbing slurry, and then the water-absorbing slurry is coated on the hydrophobic layer by scraping, spraying or rolling, and is dried at a temperature from the room temperature to 90° C. for 15 mins-30 mins to obtain a composite gas diffusion layer.

The detailed explanation is described below in conjunction with examples.

### Example 1

A composite gas diffusion layer applied to an electrochemical hydrogen compressor, as shown in FIG. 1, included: a base layer 1, a hydrophobic layer 2, and a water-absorbing layer 3, and the base layer 1, the hydrophobic layer 2, and the water-absorbing layer 3 were sequentially stacked. The base layer 1 was carbon fiber cloth.

Further, the water-absorbing layer 3 included the following components in weight percentage: 8% of a first carbon black, 5% of a water-absorbing agent, and 87% of a first solvent.

Further, the water-absorbing agent was a perfluorosulfonic acid resin solution with a mass fraction of 5%: the solvent of the perfluorosulfonic acid resin solution was n-propanol, isopropanol, or ethanol.

Further, the first solvent was ethanol.

Further, the hydrophobic layer 2 included the following components in weight percentage: 7% of a second carbon black, 8% of a hydrophobic agent, 2% of a binder, and 83% of a second solvent.

Further, the hydrophobic agent was a polytetrafluoroethylene aqueous emulsion with a mass fraction of 60%.

Further, the binder was sodium carboxymethyl cellulose.

Further, the second solvent was water.

In the prepared composite gas diffusion layer, the aperture of more than 80% of the pores in the base layer 1 was 50 μm-200 μm, the aperture of the hydrophobic layer 2 was 5 μm-50 μm, and the aperture was the water-absorbing layer 3 was 1 μm-50 μm.

The thickness of the water-absorbing layer 3 was 30 μm, the thickness of the hydrophobic layer 2 was 30 μm, and the thickness of the base layer 1 was 200 μm.

A preparation method of the above-mentioned composite gas diffusion layer included the following steps:
in step S1, a hydrophobic layer was prepared: raw material components used in the hydrophobic layer were stirred at a speed of 1000 rpm/min for 3 hrs, and were left to stand for 10 hrs to obtain the hydrophobic slurry, and then the hydrophobic slurry was applied on the base layer by scraping with a scraper through a coater, and was dried in an oven at 80° C. for 20 mins, then baked in a high-temperature furnace at 250° C. for 30 mins, and then heated up to 350° C. for sintering for 30 mins to form the hydrophobic layer on the surface of the base layer; and
in step S2, a water-absorbing layer was prepared: raw material components used in the water-absorbing layer were stirred at a speed of 1000 rpm/min for 3 hrs, and were left to stand for 2 hrs to obtain the water-absorbing slurry, and then the water-absorbing slurry was coated on the hydrophobic layer by scraping with a scraper through a coater, and was dried in an oven at 60° C. for 20 mins to obtain a composite gas diffusion layer.

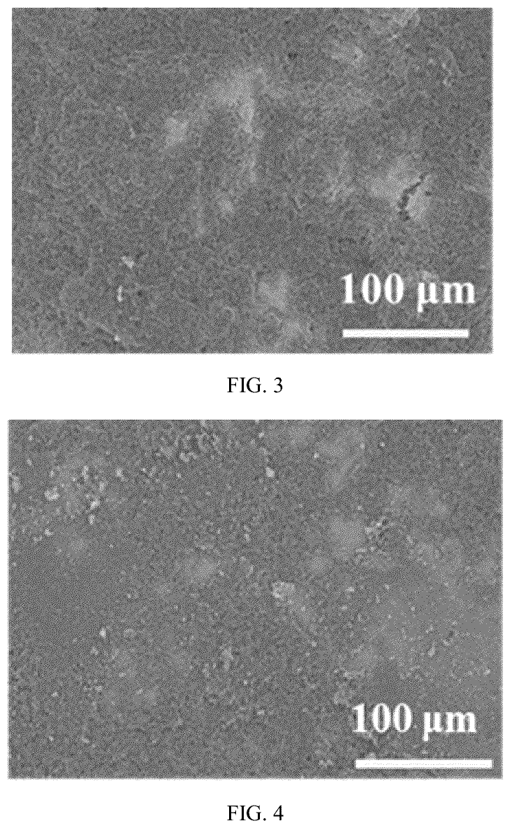

From the SEM image of the composite gas diffusion layer prepared in Example 1 as shown in FIG. 3, the composite gas diffusion layer of Example 1 has a uniform, loose and porous structure compared to the hydrophobic gas diffusion layer in the existing technology (as shown in FIG. 6).

### Example 2

The difference between the present example and Example 1 was that the mass percentage of the water-absorbing agent in the water-absorbing slurry was adjusted to be 10%, that is, the water-absorbing layer included the following components in weight percentage: 6% of a first carbon black, 10% of a water-absorbing agent, and 84% of a first solvent. The rest of the technical proposal and preparation steps of this example were the same as those of Example 1.

From the SEM image of the composite gas diffusion layer prepared in Example 2 as shown in FIG. 4, the composite gas diffusion layer of Example 2 has a uniform, loose and porous structure compared to the hydrophobic gas diffusion layer in the existing technology (as shown in FIG. 6).

### Example 3

The difference between the present example and Example 1 was that the mass percentage of the water-absorbing agent in the water-absorbing slurry was adjusted to be 20%, that is, the water-absorbing layer included the following components in weight percentage: 7% of a first carbon black, 20% of a water-absorbing agent, and 73% of a first solvent. The rest of the technical proposal and preparation steps of this example were the same as those of Example 1.

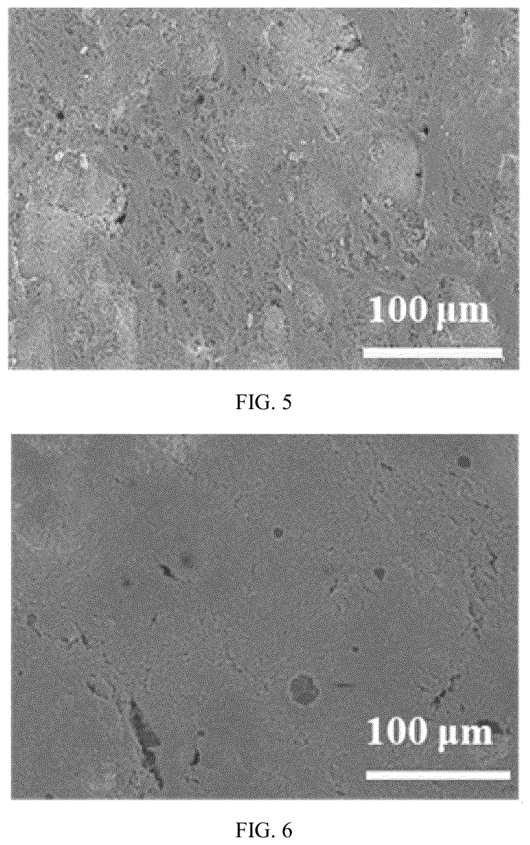

From the SEM image of the composite gas diffusion layer prepared in Example 3 as shown in FIG. 5, the composite gas diffusion layer of Example 3 has a uniform, loose and porous structure compared to the hydrophobic gas diffusion layer in the existing technology (as shown in FIG. 6).

### Example 4

The difference between the present example and Example 1 was that a double-layer water-absorbing layer was prepared, specifically, after drying the water-absorbing layer in an oven in step S2, a second water-absorbing layer was coated on the prepared water-absorbing layer, and then dried to obtain a composite gas diffusion layer with a double-layer water-absorbing layer. The content of the water-absorbing agent in each water-absorbing layer was 5%, and the thickness of each water-absorbing layer was 30 μm. The rest of the technical proposal and preparation steps of this example were the same as those of Example 1.

### Example 5

A composite gas diffusion layer applied to an electrochemical hydrogen compressor, included: a base layer, a hydrophobic layer, and a water-absorbing layer, and the base layer, the hydrophobic layer, and the water-absorbing layer were sequentially stacked. The base layer was carbon fiber felt.

Further, the water-absorbing layer included the following components in weight percentage: 10% of a first carbon black, 20% of a water-absorbing agent, and 70% of a first solvent.

Further, the water-absorbing agent was hydrophilic silicon dioxide.

Further, the first solvent was water.

Further, the hydrophobic layer included the following components in weight percentage: 10% of a second carbon black, 4% of a hydrophobic agent, 0.5% of a binder, and 85.5% of a second solvent.

Further, the hydrophobic agent was polyvinylidene fluoride.

Further, the binder was sodium carboxymethyl cellulose.

Further, the second solvent was ethanol.

Further, in the prepared composite gas diffusion layer, the aperture of more than 80% of the pores in the base layer was 50 μm-200 μm, the aperture of the hydrophobic layer was 5 μm-50 μm, and the aperture of the water-absorbing layer was 1 μm-50 μm; and
the thickness of the water-absorbing layer was 65 μm, the thickness of the hydrophobic layer was 65 μm, and the thickness of the base layer was 100 μm.

The preparation method of the above-mentioned composite gas diffusion layer included the following steps:
in step S1, a hydrophobic layer was prepared: raw material components used in the hydrophobic layer were stirred at a speed of 500 rpm/min for 3.5 hrs, and were left to stand for 5 hrs to obtain a hydrophobic slurry, and then the hydrophobic slurry was applied on the base layer by spray coating, and was dried in an oven at 70° C. for 25 mins, then baked in a high-temperature furnace at 240° C. for 35 mins, and then heated to 340° C. for sintering for 35 mins to form the hydrophobic layer on the surface of the base layer; and
in step S2, a water-absorbing layer was prepared: raw material components used in the water-absorbing layer were stirred at a speed of 500 rpm/min for 3.5 hrs, and were left to stand for 1.5 hrs to obtain a water-absorbing slurry, and then the water-absorbing slurry was coated on the hydrophobic layer by spray coating, and was dried in an oven at 90° C. for 15 mins to obtain a composite gas diffusion layer.

### Example 6

A composite gas diffusion layer applied to an electrochemical hydrogen compressor, included: a base layer, a hydrophobic layer, and a water-absorbing layer, and the base layer, the hydrophobic layer, and the water-absorbing layer were sequentially stacked. The base layer was carbon fiber paper.

Further, the water-absorbing layer included the following components in weight percentage: 5% of a first carbon black, 10% of a water-absorbing agent, and 85% of a first solvent.

Further, the water-absorbing agent was hydrophilic titanium dioxide.

Further, the first solvent was ethylene glycol.

Further, the hydrophobic layer included the following components in weight percentage: 4% of a second carbon black, 10% of a hydrophobic agent, 3% of a binder, and 83% of a second solvent.

Further, the hydrophobic agent was a tetrafluoroethylene-hexafluoropropylene copolymer.

Further, the binder was sodium carboxymethyl cellulose.

Further, the second solvent was n-propanol.

In the prepared composite gas diffusion layer, the aperture of more than 80% of the pores in the base layer was 50 μm-200 μm, the aperture of the hydrophobic layer was 5 μm-50 μm, and the aperture of the water-absorbing layer was 1 μm-50 μm; and
the thickness of the water-absorbing layer was 10 μm, the thickness of the hydrophobic layer was 10 μm, and the thickness of the base layer was 300 μm.

The preparation method of the above-mentioned composite gas diffusion layer included the following steps:
in step S1, a hydrophobic layer was prepared: raw material components used in the hydrophobic layer were stirred at a speed of 1500 rpm/min for 2.5 hrs, and were left to stand for 15 hrs to obtain a hydrophobic slurry, and then the hydrophobic slurry was applied on the base layer by roll coating, and was dried in an oven at 90° C. for 15 mins, then baked in a high-temperature furnace at 260° C. for 25 mins, and then heated to 360° C. for sintering for 25 mins to form the hydrophobic layer on the surface of the base layer; and
in step S2, a water-absorbing layer was prepared: raw material components used in the water-absorbing layer were stirred at a speed of 1500 rpm/min for 2.5 hrs, and were left to stand for 2.5 hrs to obtain a water-absorbing slurry, and then the water-absorbing slurry was coated on the hydrophobic layer by roll coating, and dried in an oven at the room temperature for 30 mins to obtain a composite gas diffusion layer.

### Example 7

A membrane electrode, as shown in FIG. 2, included a catalytic layer and the composite gas diffusion layer in Example 1. The water-absorbing layer 3 of the composite gas diffusion layer in Example 1 and the catalytic layer 4 were bonded together.

### Example 8

An electrochemical hydrogen compressor included a membrane electrode in Example 6.

### Comparative Example 1

A hydrophobic gas diffusion layer included a base layer, a hydrophobic layer arranged on the base layer.

The difference between Comparative Example 1 and Example 1 was that no water-absorbing layer was provided, that is, a hydrophobic gas diffusion layer having a hydrophobic layer only was prepared in Comparative Example 1. The rest of the technical proposal and preparation steps of Comparative Example 1 were the same as those of Example 1.

### Experimental Results

### (1) Hydrophobicity Tests

The degree of hydrophobicity of the composite gas diffusion layers prepared in Example 1, Example 2, and Example 3, and the hydrophobic gas diffusion layer prepared in Comparative Example 1 were respectively tested, in which the mass percentages of the water-absorbing agent in the composite gas diffusion layers of Example 1, Example 2, and Example 3 were 5%, 10%, and 20%, respectively. The hydrophobic gas diffusion layer in Comparative Example 1 did not contain a water-absorbing agent.

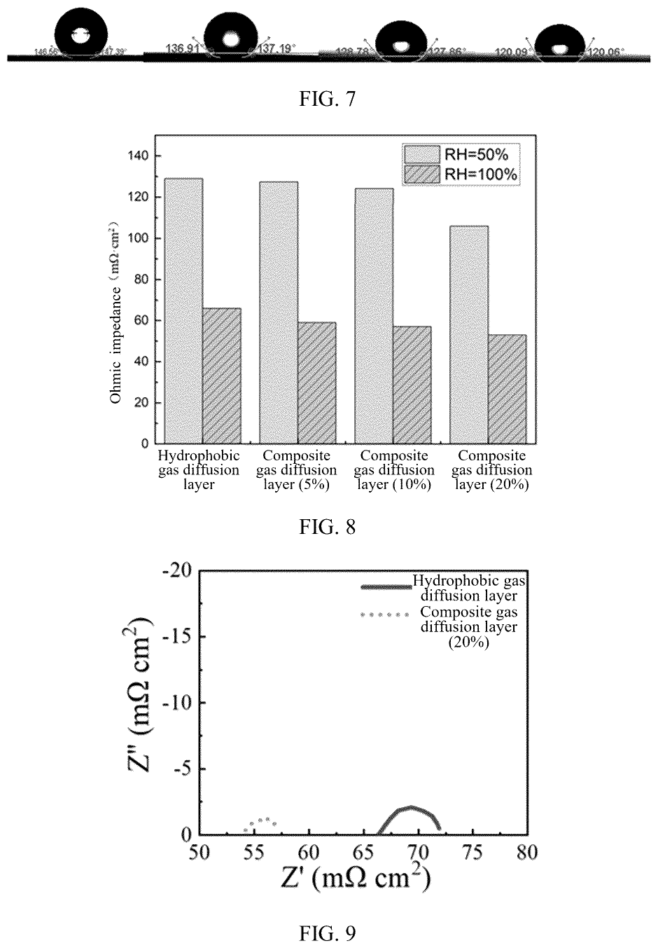

As shown in FIG. 7, the test data of the hydrophobic contact angle of the gas diffusion layers of Comparative Example 1, Example 1, Example 2, and Example 3 shows that, along with an increase in the content of the water-absorbing agent, the hydrophobic contact angle of the gas diffusion layer decreases. Comparative Example 1 had the largest hydrophobic contact angle because the gas diffusion layer did not contain any water-absorbing agent. It can be seen that the degree of hydrophobicity of the gas diffusion layer decreases with an increase in the doping amount of the water-absorbing agent in the gas diffusion layer.

### (2) Electrochemical Impedance Tests

The ohmic impedance of the membrane electrodes prepared from composite gas diffusion layers in Example 1, Example 2, and Example 3, as well as the hydrophobic gas diffusion layer in Comparative Example 1 were tested at relative humidity (RH) levels of 50% and 100%, and the test results are shown in FIG. 8.

Based on the test results shown in FIG. 8, it is evident that with an increase in the doping amount of the water-absorbing agent, the ohmic impedance of the membrane electrode decreases. Specifically, when the relative humidity (RH) is 50%, the ohmic impedance of the membrane electrode for the composite gas diffusion layer having a 20% water-absorbing agent content is the smallest, at only 106 mΩ·cm². Therefore, it is shown that the introduction of water absorbing agent in the composite gas diffusion layer is beneficial to reduce the ohmic loss of the membrane electrode. The membrane electrode of the composite gas diffusion layer with 20% water-absorbing agent content is optimal in terms of compression performance and ohmic impedance.

The ohmic impedance of the membrane electrode from the hydrophobic gas diffusion layer with a water-absorbing agent content of 20% prepared in Example 3 was compared with the hydrophobic gas diffusion layer of Comparative Example 1 alone, as shown in FIG. 9, and the ohmic impedance of the membrane electrode from the hydrophobic gas diffusion layer of Comparative Example 1 was significantly greater than the ohmic impedance of the membrane electrode from the composite gas diffusion layer with a water-absorbing agent content of 20% prepared in Example 3, so it can be seen that the composite gas diffusion layer with a water-absorbing agent content of 20% can significantly reduce the ohmic impedance of the membrane electrode.

### (3) Compression Performance Tests of Membrane Electrode

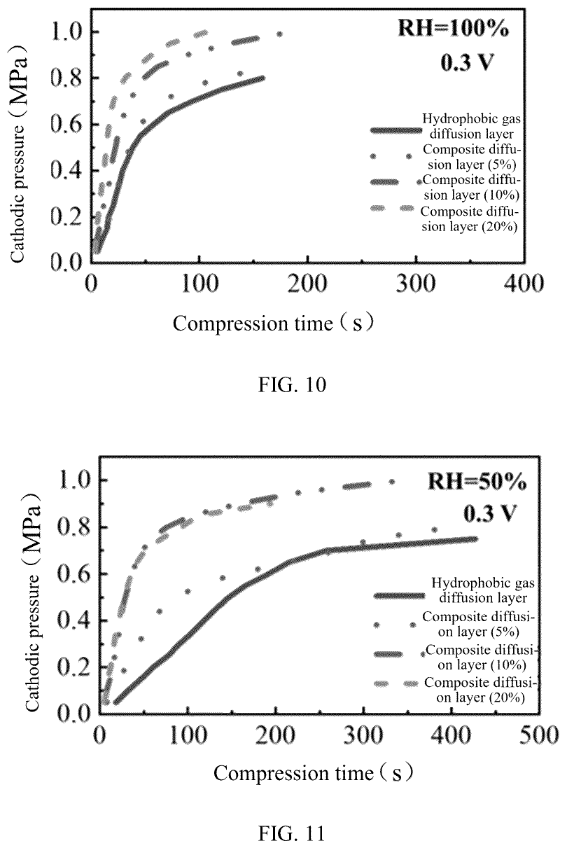

Compression performance tests were conducted on the membrane electrodes obtained from the composite gas diffusion layers prepared in Example 1. Example 2, and Example 3, and the hydrophobic gas diffusion layer prepared in Comparative Example 1, respectively, under the conditions of ambient relative humidity (RH) of 100% and 50%, respectively, and the test results are shown in FIG. 10 and FIG. 11, respectively.

From the test data in FIG. 10 and FIG. 11, it can be seen that, compared with the hydrophobic gas diffusion layer prepared in Comparative Example 1, the membrane electrodes obtained from the composite gas diffusion layers prepared in Example 1. Example 2, and Example 3, all have significantly improved compression performance at full humidity, i.e., when the ambient relative humidity (RH) is 100%. Under an ambient relative humidity (RH) of 50%, the composite gas diffusion layers prepared in Example 1. Example 2, and Example 3 showed a more significant improvement in the compression performance of the membrane electrode compared to the hydrophobic gas diffusion layer prepared in Comparative Example 1. Therefore, it is illustrated that the compression performance of the membrane electrode is enhanced more significantly by introducing a water-absorbing agent in the composite gas diffusion layer under a low-humidity environment. Because the composite gas diffusion layer of the present application has a layered structure of water absorption/hydrophobicity: the water-absorbing layer adjacent to the catalytic layer can play the role of water absorption and water storage, while the hydrophobic layer fitted with the water-absorbing layer can effectively prevent the water loss in the water-absorbing layer and play the role of water retention, and the water-absorbing layer and hydrophobic layer have a synergistic effect in maintaining the moisture of the anode, which significantly improves the compression performance under low humidity.

At an ambient RH of 50%, the compression performance when the water-absorbing agent content is 10% and 20% is comparable, and the compression performance when the water-absorbing agent content is 10% is slightly more superior, which shows that the compression performance when the water-absorbing agent content is 10% is the most optimal in a low humidity environment.

### (4) Comparison of Compression Performance Tests of Double-Layer Water-Absorbent Layer and Single-Layer Water-Absorbent Layer

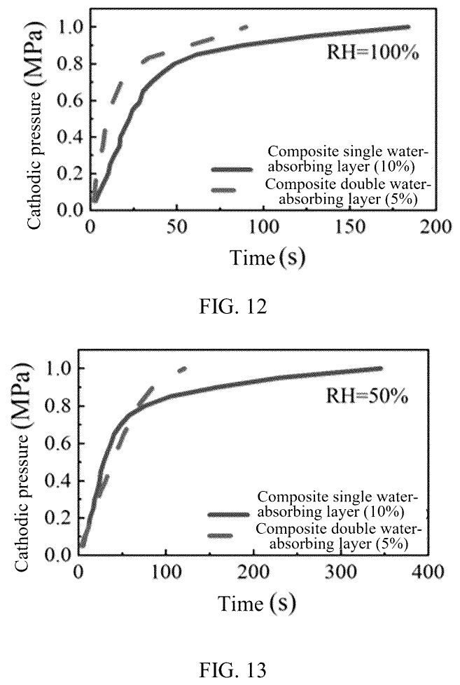

The compression performances of the membrane electrodes were separately tested for the composite gas diffusion layer with a single-layer water-absorbing layer made in Example 2 and the composite gas diffusion layer with a double-layer water-absorbing layer made in Example 4. The composite gas diffusion layer with a single-layer water-absorbing layer in Example 2 had a water-absorbing agent content of 10%. The composite gas diffusion layer with a double-layer water-absorbing layer in Example 4 had a water-absorbing agent content of 5% in each layer. And the compression performances were tested under the conditions of ambient RH of 100% and 50% respectively, the test results are shown in FIG. 12 and FIG. 13, respectively.

According to the test results of the compression performance in FIG. 12 and FIG. 13, it can be seen that under an ambient RH of 100%, the composite gas diffusion layer with a double-layer water-absorbing layer in Example 4, with a water-absorbing agent of 5% in each water-absorbing layer, has a significantly higher cathodic pressure than the composite gas diffusion layer with a single-layer water-absorbing layer in Example 2. Under an ambient RH of 50%, the composite gas diffusion layer with a double-layer water-absorbing layer in Example 4, with a water-absorbing content of 5% in each water-absorbing layer, began to show a significantly higher cathodic pressure than the composite gas diffusion layer with a single-layer water-absorbing layer in Example 2 as the compression time increases, i.e., after the compression time is about 70 s.

In addition, when the ambient RH is 100%, to compress the membrane electrode to 1 MPa, the membrane electrode corresponding to the composite gas diffusion layer with a single-layer water-absorbing layer in Example 2 took 183 s, while the membrane electrode corresponding to the composite gas diffusion layer with a double-layer water-absorbing layer in Example 4 took 90 s. When the ambient RH is 50%, to compress the membrane electrode to 1 MPa, the membrane electrode corresponding to the composite gas diffusion layer with a single-layer water-absorbing layer in Example 2 took 346 s, while the membrane electrode corresponding to the composite gas diffusion layer with a double-layer water-absorbing layer in Example 4 took 121 s.

It can be seen that the compression performance of the double-layer water-absorbing layer with a water-absorbing agent content of 5% is significantly better than that of a single-layer water-absorbing layer with a water-absorbing agent content of 10%. That is, the total water-absorbing agent contents in the composite gas diffusion layer with the double-layer water-absorbing layer and the composite gas diffusion layer with the single-layer water-absorbing layer are the same, but their thicknesses are different. In the circumstance that the total water-absorbing agent content is constant, an increase in the thickness of the water-absorbing layer can increase the water storage space, thereby improving the compression performance of the membrane electrode.

Therefore, it can be found that, when the total water-absorbing agent content remains unchanged, an increase in the thickness of the water-absorbing layer can improve the water storage capacity, and then improve the compression performance of the membrane electrode.

(5) Comparison of Ohmic Impedance Tests for Membrane Electrodes with Double-Layer Water-Absorbent Layer and Single-Layer Water-Absorbent Layer

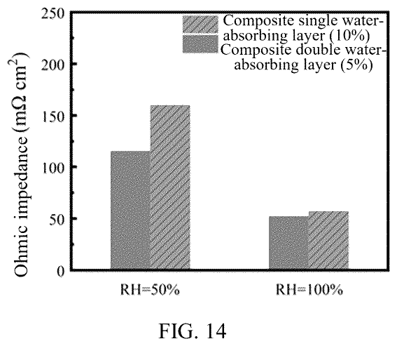

The ohmic impedance was tested for the membrane electrodes obtained from the composite gas diffusion layer having the single-layer water-absorbing layer prepared in Example 2 and the composite gas diffusion layer having the double-layer water-absorbing layer prepared in Example 4, under ambient RH of 100% and 50% respectively, the composite gas diffusion layer with a single-layer water-absorbing layer in Example 2 had a water-absorbing agent content of 10%. The composite gas diffusion layer with a double-layer water-absorbing layer in Example 4 had a water-absorbing agent content of 5% in each water-absorbing layer. Test results are shown in FIG. 14.

According to the test results of the ohmic impedance of the membrane electrodes in FIG. 14, it can be found that when the ambient RH is 100%, the ohmic impedance of the membrane electrode obtained from the composite gas diffusion layer with the double-layer water-absorbing layer in Example 4 is 51 mΩ·cm², which is lower than the ohmic impedance (57 mΩ·cm²) of the membrane electrode obtained from the composite gas diffusion layer with a single-layer water-absorbing layer in Example 2. When the ambient RH is 50%, the ohmic impedance of the membrane electrode obtained from the composite gas diffusion layer with the double-layer water-absorbing layer in Example 4 is 116 mΩ·cm², which is significantly lower than that of the composite gas diffusion layer with the single-layer water-absorbing layer in Example 2 (129 mΩ·cm²). It can be seen that, similar to the above results from the compressive performance tests, while the content of the total water-absorbing agent remains constant, an increase in the thickness of the water-absorbing layer can increase the water storage space, thereby reducing the ohmic impedance of the membrane electrode. Especially in a dry environment (for example, when RH is 50%), as content of the total water-absorbing agent remains unchanged, an increase in the thickness of the water-absorbing layer can greatly reduce the ohmic impedance of the membrane electrode, thereby improving the compression performance of the membrane electrode at low humidity.

The above are only the preferred embodiments of the present application, not to limit the present application, any modifications, equivalent substitutions and improvements made without departing from the spirit and principles of the present application are within the scope of protection of in the present application.

What is claimed is:

1. A composite gas diffusion layer applied to an electrochemical hydrogen compressor, comprising:
a base layer;
a hydrophobic layer; and
a water-absorbing layer;
wherein the base layer, the hydrophobic layer, and the water-absorbing layer are sequentially stacked.

2. The composite gas diffusion layer according to claim 1, wherein,
the water-absorbing layer comprises following components in weight percentage:

| | |
|---|---|
| a first carbon black | 5%-10%; |
| a water-absorbing agent | 5%-20%; and |
| a first solvent | 70%-90%; |
| and wherein, | |

the hydrophobic layer comprises following components in weight percentage:

| | |
|---|---|
| a second carbon black | 4%-10%; |
| a hydrophobic agent | 4%-10%; |
| a binder | 0.5%-3%; and |
| a second solvent | 77%-90%. |

3. The composite gas diffusion layer according to claim 2, wherein,
the water-absorbing agent comprises one or a combination of two or more of nitric acid, hydrophilic silicon dioxide, hydrophilic titanium dioxide, hydrophilic tin dioxide, polyvinyl alcohol, cellulose, perfluorosulfonic acid resin solution, and agarose; and/or
the first solvent comprises one or a combination of two or more of ethanol, water, ethylene glycol, and n-propanol or isopropanol; and/or
the second solvent comprises one or a combination of two or more of ethanol, water, ethylene glycol, and n-propanol or isopropanol.

4. The composite gas diffusion layer according to claim 2, wherein the hydrophobic agent comprises one or a combination of two or more of polytetrafluoroethylene, polyvinylidene fluoride, polychlorotrifluoroethylene, and a tetrafluoroethylene-hexafluoropropylene copolymer or a tetrafluoroethylene-perfluoro(alkyl vinyl ether) copolymer; and/or
the binder comprises sodium carboxymethylcellulose.

5. The composite gas diffusion layer according to claim 1, wherein the base layer comprises one or a combination of two or more of carbon fiber cloth, carbon fiber felt, carbon fiber paper, stainless steel mesh, foamed titanium, titanium felt, and powder sintered titanium plate.

6. The composite gas diffusion layer according to claim 1, wherein more than 80% of pores in the base layer have an aperture of 50 μm-200 μm, the hydrophobic layer has an aperture of 5 μm-50 μm, and the water-absorbing layer has an aperture of 1 μm-50 μm; and
wherein the water-absorbing layer has a thickness of 10 μm-65 μm, the hydrophobic layer has a thickness of 10 μm-65 μm, and the base layer has a thickness of 100 μm-300 μm.

7. A preparation method of the composite gas diffusion layer according to claim 1, comprising following steps:
preparing a hydrophobic slurry from raw material components used in the hydrophobic layer, coating the hydrophobic slurry on a surface of the base layer, carrying out a drying treatment, and sintering to form the hydrophobic layer; and
preparing a water-absorbing slurry from raw material components used in the water-absorbing layer, coating the water-absorbing slurry on a surface of the hydrophobic layer, and carrying out a second drying treatment to obtain the composite gas diffusion layer.

8. The preparation method according to claim 7, further comprising: stirring the raw material components used in the hydrophobic layer at a speed of 500 rpm/min-1500 rpm/min for 2.5 hrs-3.5 hrs, leaving to stand for 5 hrs-15 hrs to obtain the hydrophobic slurry, and applying the hydrophobic slurry on the base layer by scraping, spray coating, or roll coating, drying at 70° C.-90° C. for 15 mins-25 mins, then baking at 240° C.-260° C. for 25 mins-35 mins, and heating up to 340° C.-360° C. for sintering for 25 mins-35 mins to form the hydrophobic layer on the surface of the base layer; and
stirring the raw material components used in the water-absorbing layer at a speed of 500 rpm/min-1500 rpm/min for 2.5 hrs-3.5 hrs, leaving to stand for 1.5 hrs-2.5 hrs to obtain the water-absorbing slurry, and applying the water-absorbing slurry on the hydrophobic layer by scraping, spray coating, or roll coating, drying at a temperature from a room temperature to 90° C. for 15 mins-30 mins to obtain the composite gas diffusion layer.

9. The preparation method according to claim 6, wherein,
the water-absorbing layer comprises following components in weight percentage:

| | |
|---|---|
| a first carbon black | 5%-10%; |
| a water-absorbing agent | 5%-20%; and |
| a first solvent | 70%-90%; |
| and wherein, | |

the hydrophobic layer comprises following components in weight percentage:

| | |
|---|---|
| a second carbon black | 4%-10%; |
| a hydrophobic agent | 4%-10%; |
| a binder | 0.5%-3%; and |
| a second solvent | 77%-90%. |

10. The preparation method according to claim 9, wherein,
the water-absorbing agent comprises one or a combination of two or more of nitric acid, hydrophilic silicon dioxide, hydrophilic titanium dioxide, hydrophilic tin dioxide, polyvinyl alcohol, cellulose, perfluorosulfonic acid resin solution, and agarose; and/or
the first solvent comprises one or a combination of two or more of ethanol, water, ethylene glycol, and n-propanol or isopropanol; and/or
the second solvent comprises one or a combination of two or more of ethanol, water, ethylene glycol, and n-propanol or isopropanol.

11. The preparation method according to claim 9, wherein the hydrophobic agent comprises one or a combination of two or more of polytetrafluoroethylene, polyvinylidene fluoride, polychlorotrifluoroethylene, and a tetrafluoroethylene-hexafluoropropylene copolymer or a tetrafluoroethylene-perfluoro(alkyl vinyl ether) copolymer; and/or
the binder comprises sodium carboxymethylcellulose.

12. The preparation method according to claim 7, wherein the base layer comprises one or a combination of two or more of carbon fiber cloth, carbon fiber felt, carbon fiber paper, stainless steel mesh, foamed titanium, titanium felt, and powder sintered titanium plate.

13. The preparation method according to claim 7, wherein more than 80% of pores in the base layer have an aperture of 50 μm-200 μm, the hydrophobic layer has an aperture of 5 μm-50 μm, and the water-absorbing layer has an aperture of 1 μm-50 μm; and
wherein the water-absorbing layer has a thickness of 10 μm-65 μm, the hydrophobic layer has a thickness of 10 μm-65 μm, and the base layer has a thickness of 100 μm-300 μm.

14. A membrane electrode, comprising a catalytic layer and a composite gas diffusion layer, wherein the water-absorbing layer in the composite gas diffusion layer is fitted on the catalytic layer; and
the composite gas diffusion layer is applied to an electrochemical hydrogen compressor, comprising:
a base layer;
a hydrophobic layer; and
a water-absorbing layer;
wherein the base layer, the hydrophobic layer, and the water-absorbing layer are sequentially stacked.

15. The membrane electrode according to claim 14, wherein,
the water-absorbing layer comprises following components in weight percentage:

| | |
|---|---|
| a first carbon black | 5%-10%; |
| a water-absorbing agent | 5%-20%; and |
| a first solvent | 70%-90%; |
| and wherein, | |

the hydrophobic layer comprises following components in weight percentage:

| | |
|---|---|
| a second carbon black | 4%-10%; |
| a hydrophobic agent | 4%-10%; |
| a binder | 0.5%-3%; and |
| a second solvent | 77%-90%. |

16. The membrane electrode according to claim 15, wherein,
the water-absorbing agent comprises one or a combination of two or more of nitric acid, hydrophilic silicon dioxide, hydrophilic titanium dioxide, hydrophilic tin dioxide, polyvinyl alcohol, cellulose, perfluorosulfonic acid resin solution, and agarose; and/or
the first solvent comprises one or a combination of two or more of ethanol, water, ethylene glycol, and n-propanol or isopropanol; and/or
the second solvent comprises one or a combination of two or more of ethanol, water, ethylene glycol, and n-propanol or isopropanol.

17. The membrane electrode according to claim 15, wherein, wherein the hydrophobic agent comprises one or a combination of two or more of polytetrafluoroethylene, polyvinylidene fluoride, polychlorotrifluoroethylene, and a tetrafluoroethylene-hexafluoropropylene copolymer or a tetrafluoroethylene-perfluoro(alkyl vinyl ether) copolymer; and/or
the binder comprises sodium carboxymethylcellulose.

18. The membrane electrode according to claim 14, wherein the base layer comprises one or a combination of two or more of carbon fiber cloth, carbon fiber felt, carbon fiber paper, stainless steel mesh, foamed titanium, titanium felt, and powder sintered titanium plate.

19. The membrane electrode according to claim 14, wherein more than 80% of pores in the base layer have an aperture of 50 μm-200 μm, the hydrophobic layer has an aperture of 5 μm-50 μm, and the water-absorbing layer has an aperture of 1 μm-50 μm; and
wherein the water-absorbing layer has a thickness of 10 μm-65 μm, the hydrophobic layer has a thickness of 10 μm-65 μm, and the base layer has a thickness of 100 μm-300 μm.

20. An electrochemical hydrogen compressor, comprising the membrane electrode according to claim 14.
